(19) United States
(12) Patent Application Publication
(10) Pub. No.: US 2003/0208449 A1
(43) Pub. Date: Nov. 6, 2003

(54) Credit card fraud prevention system and method using secure electronic credit card

(76) Inventor: Yuanan Diao, Charlotte, NC (US)

Correspondence Address: YUANAN DIAO, 3401 Thistle Bloom Ct, Charlotte, NC, 28269, US

(21) Appl. No.: 10/138,863

(22) Filed: May 6, 2002

(51) Int. Cl. G06F 17/60

(52) U.S. Cl. 705/67

(57) ABSTRACT

A coding and deciphering system is used to prevent fraudulent credit card transactions. The traditional plastic credit card is replaced by an electronic credit card that may look like a credit card sized calculator. The electronic credit card is password protected. After activated by entering the correct password, it turns the data of a transaction into an enciphered code uniquely associated to that transaction. Such an enciphered code must accompany the un-coded transaction data for each transaction. The computer of the credit company deciphers this code by using the information stored in the authorized user's account. The deciphered code is used to compare with the un-coded transaction data. The transaction is authorized if a match is found, otherwise the transaction is denied. The extremely high level of security this method provides will make most credit card fraud impossible.

### CROSS-REFERENCE TO RELATED APPLICATIONS

U.S. Patent Documents

U.S. Pat. No. 6,095,413 August. 2000. Tetro et al. 235/380.

### STATEMENT REGARDING FEDERALLY SPONSORED RESEARCH OR DEVELOPMENT

This invention is not associated with any federally sponsored research or development.

### BACKGROUND OF THE INVENTION

1. Field of the Invention

The present invention relates to various forms of credit card transaction authorization processes, with an aim at eliminating the fraudulent use of credit cards by unauthorized users.

2. Description of Related Art

In today's world, most people use credit cards to carry out financial transactions due to economic reasons or for the sake of convenience. However, fraudulent credit card use is a serious problem. Credit card companies and consumers lose large amount of money each year due to fraudulent credit card transactions. Some of these fraudulent activities are hard to fight because the current system and method of authorizing a credit card transaction is seriously flawed. Usually, a person only needs to present the credit card at a transaction (such as at the checkout in a retail shop) and signs on the merchant copy of the receipt. Sometimes the merchant may compare the signature on the receipt to the signature on the card to determine if the person carrying out the transaction is the authorized user of the card. However, very often, such comparison is either not made at all, or not careful enough to tell slight differences. Since all the information about the card is printed on the card (including the card user's name, account number, expiration date and the signature of the card user), a person who has stolen a credit card for fraudulent transactions may have practiced imitating the card user's signature before attempting using the credit card. Some merchants request the user to show his/her driver's license in an effort to eliminate such fraudulent transactions. Although this may prevent some such activities, it cannot catch the thief since when requested, the thief can simply state that he/she has forgotten to bring a driver's license and walk out the shop, and go on to try next shop. If the thief has a means of obtaining a fake driver's license, then even checking the driver's license will not prevent such frauds. In short, if a credit card is lost or stolen, then it can be easily used for fraudulent transactions. Unless the credit card user realizes that his/her card is lost and reports to the credit company right away, the result can be devastating. Another form of credit card fraud does not even involve the credit card physically. When a credit card transaction is carried out over the phone or the Internet, the user of the credit card is usually required to provide the credit card number, user name, user address and card expiration date. An unauthorized person can obtain all these without having to have the card on hand. For instance, when a person makes a phone or Internet order, the merchant will have a record of the above information. If this information is leaked to a third party, then this credit card is subject to a fraudulent use. In theory, the more transactions a person makes over the phone or Internet, the more vulnerable his card becomes. In fact, this security issue concerns many people and is a major reason for many to stay away from phone or Internet orders. In the case that a transaction is carried out in a shop, it is not efficient and realistic to rely on the merchants to increase the security check (such as careful ID check and signature comparison). Some have suggested that a PIN such as the user's social security number to be used as an additional identity check. This method requires that the card user to provide his/her PIN for each transaction. While this certainly would increase the level of security of the transaction, it cannot totally prevent fraudulent credit card transactions. For instance, a skilled person can find a user's social security number fairly easily through the public domain, since the social security number of the user is used in many legal documents involving him/her and such documents are often available in the public domain. Furthermore, when making remote transactions such as phone or Internet orders, the credit card user would have to give out his/her PIN or the transaction will not be authorized if the transactions require the input of PIN. But once he/she gives out this number, it immediately becomes vulnerable since a third party may now have access to it. Once an unauthorized person obtains this PIN, this prevention effort fails. Methods of this nature will not ease people's fear that their card information may be stolen over the phone or Internet transactions. The main purpose of this invention is to provide a system and method that will prevent credit card fraud in a highly effective way.

### BRIEF SUMMARY OF THE INVENTION

The system of this invention includes a main computer (of a credit card company) used to process the transactions made between a merchant and a credit card user of the credit card company, a small size electronic device that serves as a credit card (in other word, an electronic credit card), a device that communicates between the main computer and the electronic credit card. The key idea of this invention is to replace the current plastic credit card with magnetic strip by an electronic device, which we will call an electronic credit card hereon. The electronic credit card is password protected and is preloaded with a coding program. For each transaction, the (user password activated) electronic credit card enciphers the transaction data using its coding program. More specifically, the enciphering algorithm used for this transaction is determined by the date and the sequential number of the transaction, where the sequential number of the transaction is the total number of transactions (including the said transaction) made on that electronic credit card in that day. Thus, this enciphered code is uniquely associated to that transaction. Upon receiving the transaction authorization request, the main computer retrieves the corresponding deciphering key from the user's account using the date and sequential number of the transaction, and uses it to decipher the enciphered code produced by the electronic credit card. The deciphered number is then compared with the plain transaction data. A match means the enciphered code is produced by the user's electronic credit card and the transaction is authorized. Otherwise the transaction is denied. Since the enciphered code produced by the electronic credit card is uniquely tied to a particular transaction, it cannot be used for a different transaction. Hence an enciphered code is useless for all other transactions. Thus, a high level of security for the credit card transactions is achieved: merely knowing the user's credit card number and other personal information is no longer enough to carry out a transaction since such a valid secret code cannot be produced without the electronic credit card, a stolen electronic credit card cannot be used without knowing its password. A coding method is used in this invention to demonstrate that such a coding system can be easily implemented, and the security level achieved is so high that almost all current forms of fraudulent credit transactions can be eliminated. Practically, the only way for an unauthorized person to make a fraudulent transaction under the system and method of this invention is for him/her to steal the user's electronic credit card AND the user's password, which is much harder in general.

### DETAILED DESCRIPTION OF THE INVENTION

The following description is provided to enable any person skilled in the art and science to make and use the invention and sets forth the best modes contemplated by the inventor of carrying out his invention. Various modifications remain readily apparent to those skilled in the art and science, since the general principles of the present invention have been defined herein specifically to provide an extremely high level of security against fraudulent credit card transactions.

Terms Used in This Description:

Company:

A financial institute such as a credit card company that issues its users credit cards or bankcards. User: A user holding a credit card or a bankcard of the said company. Merchant: A retailer that does business transaction with the user and charges the transaction amount to the company (on the user's account).

Devices involved in this invention: A main computer, owned by the company and used to authorize or deny transactions made between a merchant and a user, a database used to store user accounts and related information in a secure way such that only the main computer (or authorized personnel of the company) may access it, a (calculator like) device that serves as a credit card, namely an electronic credit card, owned by the user, a reading device, owned by the merchant, that communicates between the main computer and the electronic credit card. A random number generator is needed and some simple software programs are needed.

A simple enciphering scheme is used in this description for illustration purposes. This is used to show what level of security may be obtained by using this invention and how feasible it is to implement this invention. This coding method should not limit our invention in the general principle in any way. Any other practical enciphering technique can be readily applied in our system so long as it achieves the desired security level and is feasible for implementation. As a result, the form and length of codes used in this description are related to this enciphering method and it should be understood that they may be different should a different enciphering scheme is applied.

The Preparation of the System:

This involves the preparation of the main computer, the database that contains the user account information and the electronic credit card. This step has nothing to do with the user and the user needs not to understand anything about this in order to use this system and method. This is just like the user needs not to know anything about how the current plastic credit card is made and how the authorization process of a transaction works in order for him/her to use the card. Two programs are to be made at this step. For each user's electronic credit card, an enciphering program is created and installed in its chip. The corresponding deciphering information is stored in the user's account. The main computer is equipped with a universal deciphering program but the program calls for specific deciphering information input from the user's account. The enciphering program of the electronic credit card can only be activated after a correct password is entered. The merchant needs to have a device to communicate between the electronic credit card and the main computer. The role of this device is just like a credit card reader currently used on the market. The communication can be carried out by any readily applied means. Either the electronic credit card or its password needs to be delivered to the user first, and the other can be delivered only after the user confirms the receipt of the first delivery.

How the system and method work:

1. What is required of the merchant and the user:

The Transaction in a Retail Shop:

The user buys the good and proceeds to check out. He/she enters the password into the electronic credit card to activate its transaction mode (that is, the enciphering program). He/she (or the cashier at the shop) then inserts the electronic credit card into the slot of the electronic credit card reader and the transaction is handled automatically. After the transaction, the electronic credit card automatically shuts off its transaction mode and the user takes back the electronic credit card. This is all the user needs to do. Even if the user forgets to take back the electronic credit card, it cannot be used for another transaction since the transaction mode has been automatically shut off. The user does not need any other knowledge about the electronic credit card in order to use it. But the user does need to have some basic skills on how to enter a password and how to protect his/her password.

The Transaction at a Gas Station or at a Teller Machine:

At the gas station, the user activates his/her electronic credit card and inserts it into the card reader. He/she proceeds to pump gas. After he/she finishes, the card reader and the electronic credit card automatically complete the transaction. The user takes back his/her electronic credit card. This procedure is similar at a teller machine, except that the user will first enter the transaction amount into the teller machine indicating how much cash he/she wishes to withdraw.

The Transaction over the Phone or the Internet:

The user contacts the merchant and is informed of the charge price of the merchandize. To complete the transaction, the merchant asks for the user's credit card number and the enciphered transaction code. The user activates his/her electronic credit card by entering the correct password. He/she then enters the transaction amount into the electronic credit card through its keypad. The electronic credit card returns the enciphered code on its screen, and the user read it to the merchant. This is all the user needs to do. Since this code is uniquely tied to this transaction with the charge amount the user had put into the electronic credit card, the merchant will not be able to complete the transaction if he/she later changes the charge amount (this adds an additional security for the user). If someone obtains the user's account number with this particular code, it is useless since the main computer will not authorize it when it finds out that the sequential number of that transaction has been used from the transaction history record in the user's account. As we will see, it is practically impossible for anyone to create a valid code without the hold of the electronic credit card and its password at the same time. Thus, there is no longer any reason that the user should be fearful that his/her card may be subject to fraudulent transactions simply because his/her card information is given out. The user needs not to know how and why this works, but the company can certainly assure him/her that there will be NO chance that a fraudulent transaction can be made on his/her card when the user carries out transactions over the phone or the Internet.

2. What is the enciphering scheme and how it works:

For each user of the company, first generate 1000 random 10-digit whole numbers that contain no repeated digits. For instance, 1235890211 is not such an integer since digits 1 and 2 are repeated. 3679021458 would be a candidate since it contains no repeated digits. Next, create another 1000 random 10-digit whole numbers but the digits are allowed to repeat in this case. For instance, the two numbers just cited would be both valid candidates. Finally, a starting date for the account is set as well. This can be a date close, but prior to the delivery date of the electronic credit card. This number along is stored separately from the other numbers. Now we have three sets of numbers and they are stored in the user's account in three lists, arranged in a sequential order. The following is a partial view of an example of such lists, in which only the first ten numbers are shown from the first two lists:

Notice that the third number in List 3 is the starting date of the account, which will serve as the seed for selecting the coding algorithms. The three digit number in front of a ten digit number is the sequential number of that ten digit number, that is, the position of the ten digit number in the list. The storage space taken by these numbers is only about 20,000 digits. It is possible to reduce this to 3000 or even less while achieving the same goals we want. However, the illustration would be more complicated. These lists are also to be stored in the chip of the user's electronic credit card.

Each number in List 1 defines a ten-digit permutation. A permutation of a

| List 1 | List 2 | List 3 |
|---|---|---|
| 001.3459820716 | 001.3654028364 | 02 28 2002 |
| 002.0983567241 | 002.9927354001 | |
| 003.3749028516 | 003.8364875967 | |
| 004.8709135462 | 004.8723649854 | |
| 005.5308492761 | 005.8563539505 | |
| 006.1905738642 | 006.3575173930 | |
| 007.7352901846 | 007.0503853378 | |
| 008.0125879364 | 008.2545943836 | |
| 009.8129764350 | 009.4263854044 | |
| 010.9875430126 | 010.5373094543 | |

ten-digit number is simply a re-arrangement of its digits. For instance, the number x=3459820716 defines a ten-digit permutation Pₓ as follows: let a₁a₂a₃a₄a₅a₆a₇a₈a₉a₁₀ be a ten-digit integer, i.e., a₁ is its first digit, a₂ is its second digit, and so on. The first digit of 3459820716, i.e., 3, means to send a₁ to the fourth digit in the new number, the second digit 4 means to send a₂ to the fifth digit in the new number, and so on. The re-arranged number is now a₇a₉a₆a₁a₂a₃a₁₀a₈a₅a₄. We write this as

Pₓ(a₁a₂a₃a₄a₅a₆a₇a₈a₉a₁₀)=a₇a₉a₆a₁a₂a₃a₁₀a₈a₅a₄

in a mathematical way. For example, for x=3459820716, we would have

Pₓ(2390325389)=5822399330.

So the numbers in List 1 define 1000 (different) ten-digit permutations. To recover the number 2390325389 from 5822399330, we simply apply 3459820716 in the reversed order: 3 means taking the fourth digit of 5822399330 into first, 4 means taking the fifth digit of 5822399330 into second, and so on. The corresponding function is written as Pₓ⁻¹, namely the inverse function of Pₓ. A simple computer program can be easily written to complete such a permutation and its corresponding reversed permutation.

Each number in List 2 is used to define an operation on a ten-digit integer. We will call this a modular operation. Let us explain how this works by an example. Say the number y=9927354001 is taken from List 2 and we want to apply the modular operation M_{y} defined by it to the number 3468973203. We first add the corresponding digits of 9927354001 and 3468973203. The result is (12 13 8 15 12 12 7 2 0 4). Since 12=2 mod10, 13=3 mod10 , and so on, we obtain (2 3 8 5 2 2 7 2 0 4). That is,

M_{y}(9927354001)=2385227204.

To recover 3468973203 from 2385227204, we simply subtract each digit of 9927354001 from its corresponding digit in 2385227204, if the result is negative, we will add 10 to it. This is simply the inverse operation of M_{y} and is denoted M_{y}⁻¹. Again, a simple computer program can be written to complete such a modulation and its inverse.

The transaction data, in this illustration, is a ten digit-number. The first six are the transaction amount and the last four are the month and date of the transaction. For instance, a transaction made on Apr. 28, 2002 with the amount of $1345.98 is read as 1345980428. If the amount contains less than six digits, 0's are added in the front to make it up to six digits. For instance, if in the above transaction, the amount is $34.08, then the number will be read as 0034080428 by the main computer. This is also how the electronic credit card reads and inputs this data. To encipher the transaction data, the electronic credit card will follow the steps below:

(a) looking into its record to see how many transactions have been made;

(b) adding one to that number, which is the sequential number (denoted by S) of the current transaction;

(c) calculating the number of days (denoted by E) elapsed from its starting date to the date of the transaction;

(d) retrieving the number xₗ_{₁} from List 1 with the sequential number:

l₁=100(n₁+n₄)+10n₂+n₃+S mod1000,

where n₁, n₂, n₃ and ₄ are the first, second, third and fourth digits of E correspondingly and a mod1000 operation is needed if the above resulted number is larger than 1000, since the list only contains 1000 numbers;

(e) retrieving the number yₗ_{₂} from List 2 with the sequential number:

l₂=200(n₁+n₄)+20n₂+2n₃ +S−1mod1000,

where n₁, n₂, n₃ and n₄ are as defined in (d) and the mod1000 is necessary for the same reason;

(f) enciphering the transaction data number z by applying Pₓ_{ₗ}^{₁} to it, followed by M_{yl}_{₂}, i.e., the secret code is

\hat{z}=M_{yl}_{₂}oPₓₗ_{₁}(z).

Here is an example of the whole process. Assume that a transaction is made on May 7, 2008 with a charge amount of $67.90, that this is the thirteenth transaction of the day (made on the said electronic credit card) and 1231 days have elapsed since its starting date. So the transaction data is z=0067900507. The electronic credit card determines that E=1231 and S=13. It then calculates that

lₗ=100(1+1)+10(2)+3+13=246

and

l₂=200(1+1)+20(2)+2.3+13−=478.

These two numbers are then used to retrieve xₗ_{₁} from List 1 and yₗ_{₂} from List 2. Assume further that xₗ_{₁}=2871906543 and Yₗ_{₂}=3754032342. It then enciphers the data by the formula

M_{yl}_{₂}o Pₓₗ_{₁}(0067900507)=M_{yl}_{₂}(0737050609)=3481082941.

The final enciphered code is 3481 0829 4113, with the last two digits indicating the sequential number of the transaction. Once the main computer receives this code, it retrieves (from the user's account) the same numbers xₗ_{₁}=2871906543 and yₗ_{₂}=3754032342 from List 1 and List 2 since the same numbers E=1231 and S=13 are used and the lists are identical. It then runs the inverse algorithm using these two to recover the number 0067900507:

$$0067900507 = {P}_{{x}_{{l}_{1}}}^{- 1} ∘ {M}_{{y}_{{l}_{2}}}^{- 1} ( 3481082941 ) .$$

This, of course, matches the plain data 0067900507 sent by the merchant. If there is no other transaction numbered 13 in that day, the main computer will authorize the transaction and will leave a record in the user's account indicating the 13th transaction has been made for that day. Thus, if the same transaction data arrives again (either by mistake or intentionally), it will be rejected.

Since there are 10⁶ different pairs of x, y with x from List 1 and y from List 2, there are 10⁶ different enciphering algorithms. If 100 or less transactions are made each day, these algorithms will last 10,000 days (almost 30 years) without ever being used twice. The selection process (of x, y) described above ensures that no single number from either list will be used twice in a day, so long as the total transaction number in that day is less than 1000 (a highly unlikely situation).

3. How Secure this Method is:

(a) The chance for someone to guess a valid code: Since knowing one set of transaction data and the corresponding enciphered code produced by the electronic credit card gives no hint at all what the next coding algorithm will be, a guess in this case has to be a wild guess. There is only a 1/10 of chance to guess one digit correctly. To guess all 10 digits correctly, the chance is 1/10¹⁰, which is about the chance of winning a major lottery.

(b) How much information is required to crack the coding algorithms of the electronic card: Like any method used to make enciphered messages, once enough information is gathered about this method, it can and will be cracked. However, in our case, each algorithm will only be used at most once in a 30-year time span, yet one needs to gather at least 10 sets of transaction data coded by the same algorithm to be able to crack it. So there is virtually no way that anyone can crack any of these algorithms in a systematic way. So essentially one has to make wild guesses. The chance of guessing a pair of 10-digit numbers correctly, with their positions in the lists and the starting date (to know when this combination can be used), is much, much less than winning a major lottery.

(c) What is the chance that someone cracks the password of the electronic credit card by try and error within a reasonably short time: If the electronic credit card is lost or stolen, someone may try to crack the password by try and error. Assume that the password is 12 digits long and a person can enter a password 10 times a minute without stopping. This amounts to about 14400 tries in a day. There are 10¹² total possibilities. So the chance to crack a password in a day is about 1.44/10⁸, not much more than winning a major lottery. Besides, the electronic credit card can be programmed so that it will simply disable itself after a consecutive number of wrong password entries. Therefore, a lost or stolen electronic credit card is useless, so long as its password is not stolen at the same time.

(d) Does the chip of the electronic credit card (actually its algorithms) ever need to be replaced: Unlike the case of traditional plastic credit card, the company will no longer need to deliver any new card to the user (unless the card is lost, in which case a new card has to be issued with new chip, password and algorithms), since there is virtually no chance that someone can make fraudulent use of the electronic credit card. The most vital point now is that the user has to guard his/her password carefully. If the password is also stolen with the electronic credit card, then this method apparently fails. However, there is another method called “temporary password option” that can be used to protect the user's permanent password. This is described below.

The enhanced features of the system and method:

Since the electronic credit card is a device like a calculator and uses chips, it is possible to add some or all of the following features that will enhance the user's protection and convenience.

1. It is important to design the electronic credit card in such a way so that after each transaction, it shuts off its transaction mode automatically. If the user activates it but the transaction is not made, then the transaction mode will shut off automatically after a period of time, preferable 3 to 5 minutes.

2. The temporary password option: For added convenience and security, the electronic credit card may be equipped with a temporary password option. After activating the electronic credit card, the user chooses this option from a menu (on the screen) through the electronic credit card keypad. The user can choose and save a temporary password comprising 4 to 8 digits. Once this temporary password is entered, the electronic credit card can be activated by this temporary password during a time period that the user can set before the temporary password is entered. This can be from 1 to 8 hours, depending on the user's estimate of how long he/she will be out shopping in the public. The user may also have an option to limit the number of transactions and dollar amount allowed under this temporary password. After that time period or the number of transactions (or the dollar amount) allowed to be made under this temporary password is reached, the electronic credit card returns to its normal mode automatically and has to be activated by the original password. The temporary password is shorter and likely easier for the user to remember and enter, especially in public. Although a shorter password is much easier to crack, the electronic credit card will have a way to fight that: If a wrong password is entered, say, 5 times in a row, then the electronic credit card returns to its standard mode. This prevents an unauthorized person from getting in the electronic credit card by repeated try and error. This feature, coupled with the limited time under this temporary password and the number of transactions, amount of money can be made in this mode, makes this option a highly secure and convenient tool for the user since he/she will not have to carry or enter the permanent password in public.

3. Multiple electronic credit cards option: The electronic credit card can be made so that it can house several credit card chips. This way, one single electronic credit card device can serve as many credit cards.

4. The electronic credit card stores transaction information in its memory. When the battery is taken out, all memory will become lost. After the battery is replaced, the electronic credit card will automatically prompt the user to input the correct date, since it is an important part of the transaction. It may also ask the user to input how many transactions have been made in that day. If the user is not sure, just estimate a larger number. To avoid memory loss, the electronic credit card should be equipped with a backup battery.

5. The electronic credit card can indeed be used as a regular calculator, which of course would not require the password to operate. It may also be combined with other electronic device to for the sake of convenience.

What I claim as my invention is:

1. A system for authorizing a credit card transaction, comprising:
a method in which coding algorithms are used to produce unique enciphered codes tied to specific transactions that can only be deciphered by using information stored in the user's account;
an electronic credit card comprising: an enciphering program utilizing the method above, a communication port, a keypad and a screen, and other security, convenience programs and features;
a main computer used for credit card transaction authorization, equipped with a deciphering program capable of deciphering secret codes produced by an electronic credit card;
a random number generator;
a database where the user information, including the user account number, the de-ciphering key data, is stored;
a retrieval means for the main computer to access the user account information from the database;
a communication means between the computer used for authorizing transactions and an electronic credit card;
a method in which more than one positive integers are used to define a unique enciphering algorithm and its corresponding deciphering algorithm;
a set of randomly generated numbers for each user account, stored in that user's account and his/her electronic credit card;
a password comprising certain number of digits that is required to activate the user's electronic credit card;
means to deliver the password to the user with confirmation requested;
means to deliver the electronic credit card to the user upon the user's confirmation on receiving the password;

2. A method for authorizing a credit card transaction, comprising the steps of:
user activating the electronic credit card by entering the correct password prior to transaction;
user entering the transaction data to the electronic credit card, either through a communication device such as a modified credit card reader compatible with the electronic credit card, or through the keypad of the electronic credit card;
the electronic credit card recording the said transaction in its memory, counting the total number of transactions made in that day, choosing an enciphering algorithm with that information, enciphering the transaction data and returning a secret code that includes the sequential number of the said transaction;
the credit card reader transmitting the enciphered code, the credit card account number and plain transaction data to the authorizing computer;
the authorizing computer receiving the enciphered code and the user's account number, plain (un-coded) transaction data from the electronic credit card, either through the electronic credit card reader or through other means;
the authorizing computer accessing the database and retrieving the information needed to run the deciphering program from the user's account;
the authorizing computer deciphering the enciphered code using its deciphering program and comparing the result with the plain transaction data;
the authorizing computer denying the transaction if a match is not found;
the authorizing computer authorizing the transaction if a match is found and no other transaction is not made in that day with the same sequential number;
the authorizing computer recording the sequential number of the authorized transaction in the user's account in that day.

3. The method for authorizing a credit card transaction as recited in claim 2, wherein the electronic credit card must be activated prior to each transaction by entering the correct password.

4. A system for authorizing a credit card transaction as recited in claim 1, wherein the method used to produce unique enciphered codes tied to specific transactions that can only be deciphered by using information stored in the user's account comprising the steps of:
generating a set of random whole numbers;
defining a function that associates one or more numbers in the above set to a enciphering algorithm that enciphers a whole number of certain digits into another whole number;
defining a function that associates the date of the transaction and the sequential number of the transaction (meaning the number of transaction the user has made using that electronic credit card including that transaction) to one or more numbers in the set created above in a non-repetitive way;
combining the last two functions to define the enciphering program and taking the inverse of it to define the deciphering program.

5. A system for authorizing a credit card transaction as recited in claim 1, wherein the transaction authorizing method comprising the following steps:
generating a set of random whole numbers for each user;
storing these numbers in the user's account on the database;
storing these numbers in the user's electronic credit card;
installing the deciphering program defined in claim 4 on the authorizing computer;
installing the enciphering program defined in claim 4 on the user's electronic credit card;
the electronic credit card enciphering the transaction data using its coding program defined above;
the authorizing computer retrieving the deciphering information from the user's account;
the authorizing computer deciphering the enciphered code encoded by the electronic credit card;
the authorizing computer comparing the decoded result to that of the un-coded transaction code for a match;
the authorizing computer rejecting the transaction if the transaction sequential number of that day has been used;
the authorizing computer rejecting the transaction if a match is not found.
the authorizing computer approving the transaction if the transaction sequential number of that day has not been used and a match is found;
storing the sequential number of the said transaction in the user's account.

6. An electronic credit card as recited in claim 1, wherein said security features comprising some or all of the following:
the electronic credit card requiring user authentication for each transaction, whether the transaction is automated by a card reader or is manually made by data input through the keypad on the electronic credit card;
the electronic credit card shutting off its transaction mode automatically after a period of time when activated but left idling;
the electronic credit card creating enciphered codes uniquely tied to specific transactions using non-repeating coding algorithms;
the electronic credit card disabling itself after a consecutive number (preset by the credit card company) of invalid password entries;

7. An electronic credit card as recited in claim 1, wherein said convenience features comprising some or all of the following:
the electronic credit card having more than one slots for housing an electronic credit card chip so that it can be used as more than one credit card;
the electronic credit card having a menu on its screen showing the choices of different credit cards on it (when applicable);
the electronic credit card having all the basic features of a calculator which can be used without having to enter the transaction mode;
the electronic credit card having a “temporary password” option in which the user may substitute the permanent password by a temporary, shorter password after entering the correct permanent password first;
the electronic credit card automatically shutting off its temporary password option mode after the time period specified by the user elapses;
the electronic credit card automatically shutting off its temporary password option mode if the number of transactions exceeds the limit specified by the user;
the electronic credit card automatically shutting off its temporary password option mode if the total dollar amount of the transactions exceeds the limit specified by the user;
the electronic credit card automatically shutting off its temporary password option mode if the number of consecutive failed password entering attempts exceeds the pre-specified number set by the user;

8. The method for authorizing a credit card transaction as recited in claim 2, wherein the sequential number of a transaction is the total number of transactions, including the said transaction, made on that day using the said electronic credit card;

9. The method for authorizing a credit card transaction as recited in claim 2, wherein the enciphered code produced by an electronic credit card includes the sequential number of the transaction in a way the authorizing computer can read.
